(19) United States
(12) Patent Application Publication
(10) Pub. No.: US 2005/0048095 A1
(43) Pub. Date: Mar. 3, 2005

(54) Pesticide and method for the production thereof

(76) Inventor: Juergen Friedel, Unna (DE)

Correspondence Address: MILES & STOCKBRIDGE PC, 1751 PINNACLE DRIVE, SUITE 500, MCLEAN, VA, 22102-3833, US

(21) Appl. No.: 10/490,603

(22) PCT Filed: Feb. 28, 2002
(86) PCT No.: PCT/DE02/00762

(30) Foreign Application Priority Data
Oct. 4, 2001 (DE) 101 50 938.3

(51) Int. Cl. A01N 25/08; A01N 47/10; A01N 59/26; A01N 35/00

(52) U.S. Cl. 424/410; 424/604; 514/693; 514/479

(57) ABSTRACT

A pesticide consisting of rotationally symmetric pellets comprises a lentil or disc shape that is produced by expanding a compacted, then extruded, then sliced gelatinated mass. The bait pellets produced in this way ensure a long throw, even distribution, and high coverage and are water-resistant and non-abrasive.

The invention relates to a pesticide in the form of rotationally symmetric pellets, preferably for the extermination of slugs and snails or rats and mice, and a method for its production.

Pesticides in the form of spreadable pellets that can be used with various active ingredients for exterminating slugs and snails or rats and mice have been known for a long time.

For example, there is a slug and snail control agent, typically in cylindrical shape and based on metaldehyde, an active ingredient that destroys the mucosae of slugs and snails. With an active ingredient content ranging from 4 to 6%, 3 to 6 kg of pesticide per hectare are spread in agricultural applications and 6 kg per hectare (0.6 g/m²) are spread in amateur applications for the successful extermination of slugs and snails. In addition to the relatively large quantities used, the throw of machines spreading cylindrical snail pellets is limited to 15 m. Furthermore, the slug pellets differ in length from 3 to 8 mm, which typically results in an uneven spread pattern. This reduces the efficacy of the slug/snail control agent or requires application of more slug/snail control agent to achieve the required spread density (area coverage). In addition, any insufficient effectiveness of the slug/snail pesticide spread due to insufficient bait density is to be compensated by increased active ingredient content. Large quantities of application for sufficient coverage and increased active ingredient content are major cost factors and have an equally severe environmental impact. Especially when these products are neither non-abrasive nor water-resistant, the environment of the spread area must be considered severely contaminated.

The problems described above for a slug/snail control agent also occur with other types of pesticides.

It is the problem of the invention to create an environmentally gentle and cost-saving pesticide and a method for its production that ensures a long throw and even spread while at the same time allowing for reduced quantities per area unit and reduced active ingredient content but guaranteeing high coverage and efficacy of the bait pellets.

According to another object of the invention, the bait pellets should be non-dusting and water-blocking.

This problem is solved according to the invention by a pesticide comprising the characteristics described in claim 1.

The method according to the invention for producing the bait pellets according to claim 1 results from the characteristics of claim 6.

Other characteristics and advantageous embodiments of the invention are described in the dependent claims.

The basic inventive idea of the pesticide is a lentil or disc shape of the bait pellets which is produced by extruding a plasticized, gelatinated and compacted mass formed in an extruder by using starch and applying moisture, pressure, and heat, and by cutting the extruded mass into slices that later expand and take on a lentil or disk shape by bulging at the cut edges.

A bait granulate thus produced and shaped is characterized by excellent aerodynamic qualities, a corresponding long throw and an even spread pattern when spread by a machine. The long throw helps reduce spreading expenses and crop losses when the bait granulate is spread over farm land. The even spread pattern and high spread density that is 50% higher than that of conventional cylindrical bait pellets ensure the economical use of material and optimum effect, thereby minimizing expenditure and environmental impact. The gelatinated and highly compacted granulate has a domed shape and is non-abrasive and non-dusting so that any potential environmental impact is eliminated. The compacted and smooth particle surface in conjunction with a water blocking agent contained in the particles ensures high water resistance of the bait pellets so that these stay in their shape and retain their efficacy even after a 24-hour exposure to moisture. The homogeneous mixture of the ingredients of the bait granulate and its excellent effect due to the positive qualities mentioned above also makes it possible to reduce the active ingredient content to 3%. This further diminishes the environmental impact without limiting the efficacy of the pesticide.

In a preferred embodiment of a slug/snail control agent, the bait particles are 4 mm in diameter and up to 1.7 mm in height, one kilogram of pest control agent containing 31 g of metaldehyde, 846.1 g of wholemeal rye or wheat flour, 60 g of wheat starch, 50 g of polyacrylate, 8 g of propylene glycol, 0.8 g of Berlin blue, 4 g of sorbic acid, and 0.1 g of denatonium benzoate. The moisture (water) required for the gelatinating process when producing the bait granulate is removed in the course of the process.

One embodiment of the invention shall now be explained in more detail and with reference to the drawing to give an example of how the slug/snail control agent can be produced. Wherein:

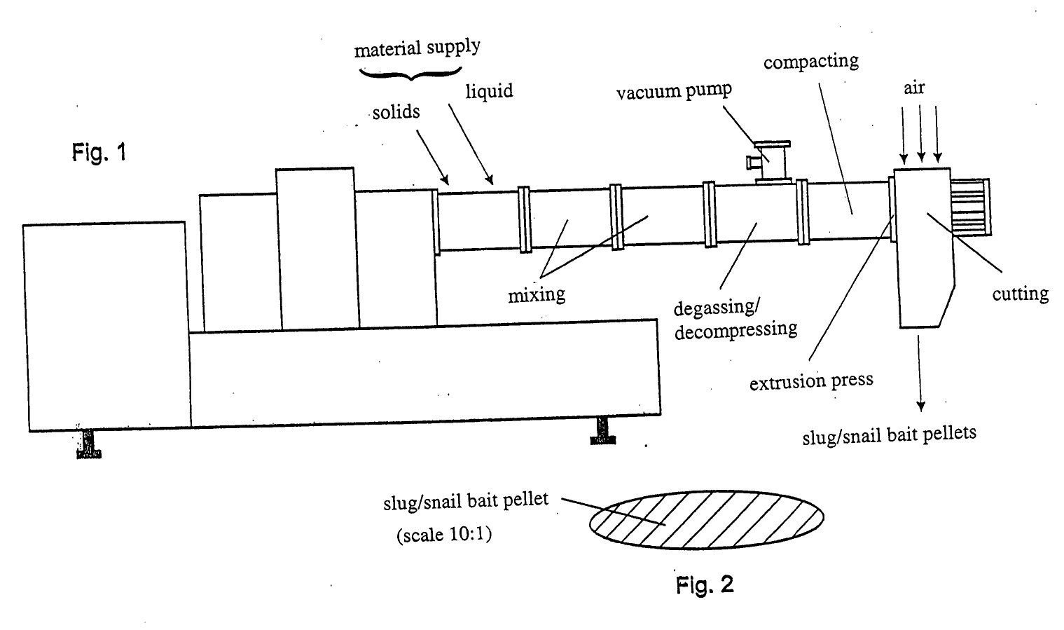

FIG. 1 shows the process flow in each section of a double-shaft extruder with counter-rotating extruder screws that engage in parallel; and

FIG. 2 shows a strongly enlarged picture of a lentil- or disc-shaped slug/snail bait pellet.

The lentil-shaped slug/snail bait pellets are produced using a double-shaft extruder with two counter-rotating extruder screws that engage in parallel.

In the embodiment described herein, the slug/snail control agent contains the following ingredients per kg of total weight.

| | | |
|---|---|---|
| 31 | g | metaldehyde, |
| 846.1 | g | wholemeal rye or wheat flour, |
| 60.0 | g | wheat starch, |
| 4.0 | g | sorbic acid (a preservative), |
| 0.8 | g | Berlin blue (a dye), |
| 8.0 | g | propylene glycol, |
| 50.0 | g | aqueous polyacrylate dispersion, and |
| 0.1 | g | denatomium benzoate (a repellent) |

water being added in the course of the process for gelatination that is removed at a later stage.

After the solids were put into the extruder and passed through a short conveyance and mixing stretch, the liquid ingredients, that is, propylene glycol, the polyacrylate dispersion and 100 g of water per kg of batch are added to the extruder.

The components are intensely intermixed in the downstream mixing zone. Mechanical energy is introduced to the plastic mass that is forming. The heat generated by mechanical shearing and kneading pressures and the moisture content cause rapid opening-up of the starch to produce a plastic, gelatinated mass. The starch and the water form colloidal solutions in the heat that gelate when the mixture is cooling. The use of glycol improves the gelatination process.

In a downstream degassing and decompressioning zone, the mass passes decompression screws. A vacuum pump connected to this zone removes any air from the plastic mass, i.e. it eliminates air pockets. The result is a homogeneous, plastic, gelatinated mass that moves on into a compacting zone for compacting for its subsequent extrusion through a perforated plate.

The compacted gelatinated strands that are 4 cm in diameter are cut immediately after extrusion under air supply into thin slices that are approximately 1.5 cm in height. In this process, the opposing disc surfaces bulge outwards and the slices take on a lentil or disk shape as shown in FIG. 2. The processing steps that follow gelatination—degassing, compacting, cutting under air supply—remove any moisture previously added to the mass.

In addition to expansion after the extrusion following the preceding compacting step, the gelatination process involving starch, water, glycol, and heat results in a very smooth and non-abrasive surface finish. The lentil-shaped pellets formed in this way while adding polyacrylate dispersion are also highly water-resistant so that they remain in their shape and effective for slug/snail control even after 24-hour exposure to water and drying by wind. Non-abrasiveness and water resistance also prevent contamination of the environment.

The disc shape that the slug/snail bait pellets take on with the expansion of the extruded slices provides the pellets with excellent aerodynamic qualities so that machine throw lengths of 24 m and an even distribution (area coverage) can be achieved with bait pellets shaped in this way. The long throw ensures minimization of personnel and machinery costs as well as losses when spreading the slug/snail bait pellets. In addition, the even spread pattern ensures optimum slug/snail control and optimum material use. Finally, the flat disc shape of the bait pellets ensures dense area coverage so that the active ingredient content, i.e. the content of metaldehyde, can be as low as 3%, which is very low as compared to conventional slug/snail bait pellets.

When comparing the lentil-shaped bait pellets described in this embodiment that are 4 mm in diameter and 1.7 mm in height and conventional cylindrical bait pellets that are 2.5 mm in diameter and 3 to 8 mm in length, the number of cylindrical pellets is 47 per gram and of lentil-shaped pellets 70 per gram, however the number of pellets needed for a quantity of application of 0.3 g/m² (3 kg/ha) is 21 for the lentil-shaped bait pellets and 14 for the cylindrical bait pellets. This means a 50% increase in coverage with the lentil-shaped bait pellets as compared to the cylindrical bait pellets for the same quantity of application.

The invention is not limited to the embodiment presented herein. Numerous modifications and other applications using other active ingredients can be made within the concept of the invention that consists in a lentil-shaped design and production of the bait pellets. Instead of metaldehyde as mentioned above, the bait pellets may contain methiocarb, thiodicarb, or ferric orthophosphate. Active ingredients such as zinc phosphide, warfarin, chlorophacinone, bromadiolone, difenacoum, brodifacoum, flocoumafen, difethialone and other cumarine derivatives are used to control rats or mice. Other modifications are conceivable that affect ingredients or the size of the lentil-shaped pellets.

1. A pesticide consisting of disc-shaped pellets that are spread over large units of farm land, preferably for controlling slugs and snails or rats and mice, wherein the pellets have a lentil or disc shape to achieve the aerodynamic qualities required for a long throw and even area coverage.

2. The pesticide according to claim 1 characterized in that the diameter of the lentil-shaped pellets is at least twice their maximum height.

3. The pesticide according to claim 1, characterized in that the pellet diameter is 4 mm and the pellet height is 1.7 mm.

4. The pesticide according to claim 1, characterized in that it contains 2 to 7% of metaldehyde, 1 to 20% of starch, 0.5 to 10% of glycol, 0.5 to 10% of a polymer, and 50 to 95% of roughage in the form of flour as well as other adjuvants for slug/snail control.

5. The pesticide according to claim 4, characterized in that one kilogram of the slug/snail control agent contains:
31 g of metaldehyde, 846.1 g of wholemeal rye or wheat flour, 60 g of wheat starch, 50 g of polyacrylate, 8 g of propylene glycol, 0.8 g of Berlin blue, 4 g of sorbic acid, and 0.1 g of denatonium benzoate.

6. The pesticide according to claim 1, characterized in that it contains other active ingredients for slug/snail control such as methiocarb, thiodicarb, or ferric orthophosphate.

7. The pesticide according to claim 1, characterized in that it contains active ingredients such as zinc phosphide, warfarin, chlorophacinone, bromadiolone, difenacoum, brodifacoum, flocoumafen, or diethialone for controlling rats and mice.

8. A method for producing the pesticide according to claim 1 wherein the starch contained in a mixture of solid ingredients of the pesticide is opened up with water by shearing and kneading forces as well as by heat in another mixing process and that, after a decompressing and degassing phase in a vacuum, a plastic, gelatinated mass is produced by cooling, compacted and extruded, the extruded strands being cut under air supply into slices that take on a lentil or disc shape.

9. The method according to claim 8 wherein glycol is added in addition to water to a mixture of solids including the active ingredient as well as flour and starch to increase gelatination of the starch and to reduce water content.

10. The method according to claim 7 wherein an aqueous polymer dispersion as a water-blocking agent, sorbic acid as a preservative, Berlin blue as a dye, and denatonium benzoate as a repellent are added to the mixture of solids.

11. The method according to claim 8, characterized in that it is conducted in a double-shaft extruder with counter-rotating extruder screws that engage in parallel, and that decompression screws and a vacuum pump are connected to the degassing section and that the extrusion dies are equipped with a ventilated cutting device.
